(19) United States
(12) Patent Application Publication
(10) Pub. No.: US 2019/0075084 A1
(43) Pub. Date: Mar. 7, 2019

(54) Distributed Lock Management Method, Apparatus, and System

(71) Applicant: Huawei Technologies Co., Ltd., Shenzhen (CN)

(72) Inventors: Wenqiang Ding, Hangzhou (CN); Chao Jiang, Hangzhou (CN); Chengjian Bao, Lagos (NG)

(21) Appl. No.: 16/179,518

(22) Filed: Nov. 2, 2018

Related U.S. Application Data
(63) Continuation of application No. PCT/CN2017/081346, filed on Apr. 21, 2017.

(30) Foreign Application Priority Data
May 5, 2016 (CN) 201610291891.X

(51) Int. Cl. H04L 29/06; H04L 29/08

(52) U.S. Cl. CPC H04L 63/0281; H04L 67/28; H04L 63/104; H04L 67/1097

(57) ABSTRACT

A distributed lock management method, apparatus, and system, where all nodes in a cluster storage system are divided into a plurality of groups, each group includes a proxy node that manages a part of all lock resources. When a non-proxy node in a group needs to apply for lock permission, the non-proxy node applies to a proxy node in the group, and the proxy node obtains the lock permission to the non-proxy node. In this way, the non-proxy node needs to know only the proxy node in the group, and directly applies to the proxy node when applying for the lock permission. The faulty of the non-proxy node does not affect the layout of a node corresponding to each lock resource in order to improve lock service availability.

### CROSS-REFERENCE TO RELATED APPLICATIONS

This application is a continuation of International Patent Application No. PCT/CN2017/081346 filed on Apr. 21, 2017, which claims priority to Chinese Patent Application No. 201610291891.X filed on May 5, 2016. The disclosures of the aforementioned applications are hereby incorporated by reference in their entireties.

### TECHNICAL FIELD

Embodiments of the present application relate to the computer field, and in particular, to a distributed lock management method, apparatus, and system.

### BACKGROUND

With continuous development of the storage field, it is hard for a single node or a pair of nodes to meet a storage requirement for performance, capacity, and reliability. Therefore, a scale-out cluster storage technology emerges. As a key technology in the scale-out cluster storage technology, a distributed lock is mainly responsible for simultaneous mutex access by a plurality of nodes to a same storage resource.

In the other approaches, a decentralized distributed lock management method is a commonly used distributed lock management method. In the decentralized distributed lock management method, a logical unit number (LUN) is in a one-to-one correspondence with a lock resource. All lock resources are distributed to all nodes in a cluster storage system using a distributed hash table (DHT) algorithm, a consistent hash algorithm, or the like. Each node manages a part of the lock resources, and provides a lock service corresponding to the lock resources, for example, granting or recalling lock permission corresponding to a lock resource. Each node notifies another node of a lock resource managed by the node such that each node generates a lock directory. The lock directory is used to indicate a node corresponding to each lock resource. When a first node needs to access a storage resource corresponding to a LUN (a LUN is also in a one-to-one correspondence with a storage resource), the first node needs to determine, according to the lock directory, a node managing the lock resource corresponding to the LUN as a second node, and to apply to the second node for lock permission of the lock resource. The first node can perform a related operation such as padlocking and writing on the storage resource only after obtaining the lock permission. For the decentralized distributed lock management method, when a node in the cluster storage system changes, for example, a node is faulty or in recovery, a layout of the lock resource on the node changes, and lock directories of all the nodes all need to be updated. The node can provide a lock service only when the lock directories of all the nodes are consistent.

However, in the other approaches, when a relatively large quantity of nodes exist in the cluster storage system, lock service availability is relatively low.

### SUMMARY

Embodiments of the present application provide a distributed lock management method, apparatus, and system in order to resolve a problem in which lock service availability is relatively low when a relatively large quantity of nodes exist in a cluster storage system.

According to a first aspect, an embodiment of the present application provides a distributed lock management method, where the method is applied to a cluster storage system, the cluster storage system includes a plurality of nodes, the plurality of nodes are divided into a plurality of groups, each group includes a proxy node that manages a lock resource and a non-proxy node that does not manage a lock resource, the proxy node in each group manages a part of all lock resources, and the method includes receiving, by a first node, a first lock request message that is sent by a second node and that is used to apply to the first node for first lock permission corresponding to a first lock resource, where the first node is a proxy node in the first group, and the second node is a non-proxy node in the first group, and sending, by the first node to the second node according to the first lock request message, a first lock grant message that is used to grant the first lock permission to the second node.

According to the distributed lock management method provided in the first aspect, when the non-proxy node in the group needs to apply for the lock permission, the non-proxy node applies to the proxy node in the group, and the proxy node in the group grants the lock permission to the non-proxy node in the group. In this way, the non-proxy node needs to know only the proxy node in the group that includes the non-proxy node, and directly applies to the proxy node when applying for the lock permission. The non-proxy node does not need to know a lock directory. Therefore, when the non-proxy node in the group changes (for example, being faulty or in recovery), a layout of the lock resource on the node does not change, and the lock directory does not need to be updated. The lock needs to be updated only when the proxy node changes. In the other approaches, when any node in the cluster storage system changes, lock directories of all nodes need to be updated. In comparison with the other approaches, a lock directory update time is reduced. A node can provide a lock service only when the lock directories are updated to be consistent. Therefore, in the present application, a lock service interruption time is reduced, and lock service availability is improved.

In a possible design, sending, by the first node, a first lock grant message to the second node according to the first lock request message includes determining, by the first node, whether a holder of the first lock permission is in the first group, and recalling, by the first node, the first lock permission from the holder of the first lock permission in the first group, and then sending the first lock grant message to the second node if the holder of the first lock permission is in the first group.

In a possible design, sending, by the first node, a first lock grant message to the second node according to the first lock request message includes determining, by the first node, whether a holder of the first lock permission is in the first group, and applying, for the first lock permission by the first node, to a third node that manages the first lock resource, and sending the first lock grant message to the second node after the third node grants the first lock permission to the first group if the holder of the first lock permission is not in the first group, where the third node is a proxy node in a second group.

According to the distributed lock management method provided in this implementation, when the holder of the first lock permission is in the first group, the first node recalls the first lock permission from a node that holds the first lock permission in the first group, and then sends the first lock grant message to the second node. When the holder of the first lock permission is not in the first group, the first node applies, for the first lock permission, to the third node that manages the first lock resource, and sends the first lock grant message to the second node after the third node grants the first lock permission to the first group. In this way, although the first lock resource is not managed by the first node, when the holder of the first lock permission is in the first group, the first node can change a node that is in the first group and that holds the first lock permission. In the other approaches, any node needs to apply, for the first lock permission, to the node that manages the first lock resource. In comparison with the other approaches, a quantity of times of interaction with the node that manages the first lock resource is reduced.

In a possible design, after the first node sends the first lock grant message to the second node, the method further includes sending, by the first node to the second node, a lock recall request message that is used to recall the first lock permission from the second node, and receiving, by the first node, a lock recall response message that is sent by the second node and that is used to release the first lock permission.

In a possible design, the method further includes receiving, by the first node, a second lock request message that is sent by a fourth node and that is used by a third group to apply to the first node for second lock permission corresponding to a second lock resource, where the second lock resource is managed by the first node, and the fourth node is a proxy node in the third group, determining, by the first node, whether the second lock resource is granted, and recalling, by the first node, the second lock resource, and then sending, to the fourth node, a second lock grant message that is used to grant the second lock permission to the third group if the second lock resource is granted.

According to the distributed lock management method provided in this implementation, the first node receives the second lock request message sent by the fourth node (that is, the other proxy node), and the second lock request message is used by the group including the fourth node to apply to the first node for the second lock permission corresponding to the second lock resource managed by the first node. When determining that the second lock permission is granted, the first node recalls the second lock permission, and then grants the second lock permission to the group including the fourth node. When the second lock permission is not granted, the first node directly grants the second lock permission to the group including the fourth node. In this way, the proxy node grants and recalls the lock permission corresponding to the lock resource managed by the proxy node.

In a possible design, when the second lock resource is granted to a non-proxy node in the first group, recalling, by the first proxy node, the second lock resource includes recalling, by the first node, the second lock resource from the non-proxy node in the first group.

In a possible design, when the second lock resource is granted to a fourth group, recalling, by the first node, the second lock resource includes recalling, by the first node, the second lock resource from a proxy node in the fourth group.

In a possible design, before the first node receives the first lock request message sent by the second node, the method further includes determining, by the first node, that the first node is a proxy node in the first group.

In a possible design, determining, by the first node, that the first node is a proxy node in the first group includes determining, by the first node according to consistent hash values of all nodes in the first group, that the first node is the proxy node.

In a possible design, the method further includes monitoring, by the first node, whether a node previous to the first node in a hash ring formed by the consistent hash values of all nodes is faulty, and updating, by the first node, the hash ring, and instructing another node other than the previous node in the first group to update the hash ring when the node previous to the first node is faulty.

In a possible design, nodes in a same group are in a same region.

In the other approaches, when lock permission is applied for, lock permission needs to be applied to a node that manages the lock permission. In comparison with the other approaches, according to the distributed lock management method provided in this implementation, a quantity of times of cross-region interaction is reduced. When the holder of the lock permission and an applier of the lock permission (that is, the node that applies for the lock permission) are in a same group, a quantity of times of network communications between groups may be effectively reduced. Particularly, when the node that manages the lock resource, the applier of the lock permission, and the holder of the lock permission are in different regions, a quantity of times of cross-region communications is effectively reduced, and a delay of lock applying is reduced.

According to a second aspect, an embodiment of the present application provides a distributed lock management method, where the method is applied to a cluster storage system, the cluster storage system includes a plurality of nodes, the plurality of nodes are divided into a plurality of groups, each group includes a proxy node that manages a lock resource and a non-proxy node that does not manage a lock resource, the proxy node in each group manages a part of all lock resources, and the method includes generating, by a second node, a first lock request message that is used to apply to the first node for first lock permission corresponding to a first lock resource, sending, by the second node, the first lock request message to the first node, where the first node is a proxy node in a first group, and the second node is a non-proxy node in the first group, and receiving, by the second node, a first lock grant message that is sent by the first node and that is used to grant the first lock permission to the second node.

In a possible design, after the second node receives the first lock grant message sent by the first node, the method further includes receiving, by the second node, a lock recall request message that is sent by the first node and that is used to recall the first lock permission from the second node, and sending, by the second node to the first node, a lock recall response message that is used to release the first lock permission after the first lock permission is released.

In a possible design, the method further includes monitoring, by the second node, whether a node previous to the second node in a hash ring formed by consistent hash values of all nodes in the first group is faulty, and updating, by the second node, the hash ring, and instructing another node other than the previous node in the first group to update the hash ring if the node previous to the second node is faulty.

In a possible design, nodes in a same group are in a same region.

For beneficial effects of the distributed lock management method provided in the second aspect and each possible implementation of the second aspect, refer to the beneficial effects brought by the first aspect and each possible implementation of the first aspect. Details are not described herein again.

According to a third aspect, an embodiment of the present application provides a distributed lock management apparatus, where the apparatus is applied to a cluster storage system, the cluster storage system includes a plurality of nodes, the plurality of nodes are divided into a plurality of groups, each group includes a proxy node that manages a lock resource and a non-proxy node that does not manage a lock resource, the proxy node in each group manages a part of all lock resources, the apparatus is a first node, and the apparatus includes a receiving module configured to receive a first lock request message that is sent by a second node and that is used to apply to the first node for first lock permission corresponding to a first lock resource, where the first node is a proxy node in the first group, and the second node is a non-proxy node in the first group, and a granting module configured to send, to the second node according to the first lock request message, a first lock grant message that is used to grant the first lock permission to the second node.

In a possible design, the granting module is further configured to determine whether a holder of the first lock permission is in the first group, and recall the first lock permission from the holder of the first lock permission in the first group, and then send the first lock grant message to the second node if the holder of the first lock permission is in the first group.

In a possible design, the granting module is further configured to determine whether a holder of the first lock permission is in the first group, and apply, for the first lock permission, to a third node that manages the first lock resource, and send the first lock grant message to the second node after the third node grants the first lock permission to the first group if the holder of the first lock permission is not in the first group, where the third node is a proxy node in a second group.

In a possible design, the apparatus further includes a recalling module, and the recalling module is configured to send, to the second node, a lock recall request message that is used to recall the first lock permission from the second node, and receive a lock recall response message that is sent by the second node and that is used to release the first lock permission.

In a possible design, the receiving module is further configured to receive a second lock request message that is sent by a fourth node and that is used by a third group to apply to the first node for second lock permission corresponding to a second lock resource, where the second lock resource is managed by the first node, and the fourth node is a proxy node in the third group, and the granting module is further configured to determine whether the second lock resource is granted, and recall the second lock resource, and then send, to the fourth node, a second lock grant message that is used to grant the second lock permission to the third group if the second lock resource is granted.

In a possible design, when the second lock resource is granted to a non-proxy node in the first group, that the granting module recalls the second lock resource includes recalling the second lock resource from the non-proxy node in the first group.

In a possible design, when the second lock resource is granted to a fourth group, that the granting module recalls the second lock resource includes recalling the second lock resource from a proxy node in the fourth group.

In a possible design, the apparatus further includes a determining module configured to determine the first node as a proxy node in the first group.

In a possible design, the determining module is further configured to determine the first node as the proxy node according to consistent hash values of all nodes in the first group.

In a possible design, the apparatus further includes a monitoring module configured to monitor whether a node previous to the first node in a hash ring formed by the consistent hash values of all nodes is faulty, and update the hash ring, and instruct another node other than the previous node in the first group to update the hash ring if the node previous to the first node is faulty.

In a possible design, nodes in a same group are in a same region.

For beneficial effects of the distributed lock management apparatus provided in the third aspect and each possible implementation of the third aspect, refer to the beneficial effects brought by the first aspect and each possible implementation of the first aspect. Details are not described herein again.

According to a fourth aspect, an embodiment of the present application provides a distributed lock management apparatus, where the apparatus is applied to a cluster storage system, the cluster storage system includes a plurality of nodes, the plurality of nodes are divided into a plurality of groups, each group includes a proxy node that manages a lock resource and a non-proxy node that does not manage a lock resource, the proxy node in each group manages a part of all lock resources, the apparatus is a second node, and the apparatus includes a generation module configured to generate a first lock request message that is used to apply to the first node for first lock permission corresponding to a first lock resource, where the first node is a proxy node in a first group, and the second node is a non-proxy node in the first group, a sending module configured to send the first lock request message to the first node, and a receiving module configured to receive a first lock grant message that is sent by the first node and that is used to grant the first lock permission to the second node.

In a possible design, the receiving module is further configured to receive a lock recall request message that is sent by the first node and that is used to recall the first lock permission from the second node, and the sending module is further configured to send, to the first node, a lock recall response message that is used to release the first lock permission after the first lock permission is released.

In a possible design, the apparatus further includes a monitoring module configured to monitor whether a node previous to the second node in a hash ring formed by consistent hash values of all nodes in the first group is faulty, and update, the hash ring, and instruct another node other than the previous node in the first group to update the hash ring if the node previous to the second node is faulty.

In a possible design, nodes in a same group are in a same region.

For beneficial effects of the distributed lock management apparatus provided in the fourth aspect and each possible implementation of the fourth aspect, refer to the beneficial effects brought by the first aspect and each possible implementation of the first aspect. Details are not described herein again.

According to a fifth aspect, an embodiment of the present application provides a distributed lock management system, including the distributed lock management apparatus described in the third aspect and each possible implementation of the third aspect, and the distributed lock management apparatus described in the fourth aspect and each possible implementation of the fourth aspect.

For beneficial effects of the distributed lock management system provided in the fifth aspect and each possible implementation of the fifth aspect, refer to the beneficial effects brought by the first aspect and each possible implementation of the first aspect. Details are not described herein again.

### BRIEF DESCRIPTION OF DRAWINGS

To describe the technical solutions in some embodiments of the present application more clearly, the following briefly describes the accompanying drawings describing some of the embodiments. The accompanying drawings in the following description show some embodiments of the present application, and persons of ordinary skill in the art may still derive other drawings from these accompanying drawings without creative efforts.

FIG. 1 is a schematic diagram of node grouping and lock resource distribution in a cluster storage system of the present application;

FIG. 2 is a flowchart of Embodiment 1 of a distributed lock management method according to the present application;

FIG. 3 is a flowchart of Embodiment 2 of a distributed lock management method according to the present application;

FIG. 4 is a schematic diagram 1 that a proxy node grants lock permission to a non-proxy node according to an embodiment of the present application;

FIG. 5 is a schematic diagram 2 that a proxy node grants lock permission to a non-proxy node according to an embodiment of the present application;

FIG. 6 is a flowchart of Embodiment 3 of a distributed lock management method according to the present application;

FIG. 7 is a schematic diagram of node monitoring in a group according to the present application;

FIG. 8 is a flowchart of Embodiment 5 of a distributed lock management method according to the present application;

FIG. 9 is a schematic structural diagram of Embodiment 1 of a distributed lock management apparatus according to the present application;

FIG. 10 is a schematic structural diagram of Embodiment 2 of a distributed lock management apparatus according to the present application;

FIG. 11 is a schematic structural diagram of Embodiment 4 of a distributed lock management apparatus according to the present application;

FIG. 12 is a schematic structural diagram of Embodiment 5 of a distributed lock management apparatus according to the present application; and

FIG. 13 is a schematic structural diagram of Embodiment 7 of a distributed lock management apparatus according to the present application.

### DESCRIPTION OF EMBODIMENTS

To make the objectives, technical solutions, and advantages of the embodiments of the present application clearer, the following clearly describes the technical solutions in the embodiments of the present application with reference to the accompanying drawings in the embodiments of the present application. The described embodiments are some but not all of the embodiments of the present application. All other embodiments obtained by persons of ordinary skill in the art based on the embodiments of the present application without creative efforts shall fall within the protection scope of the present application.

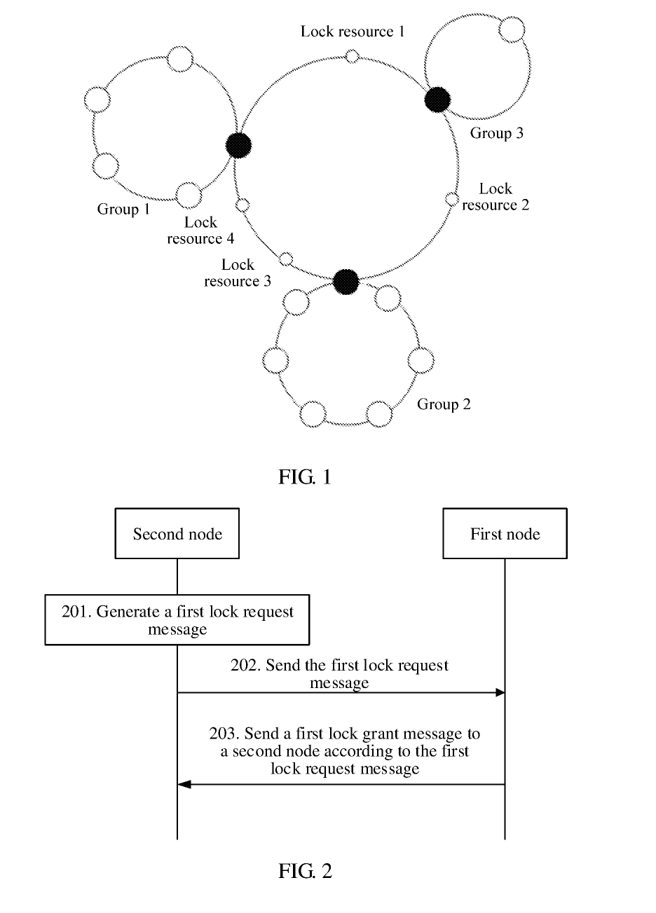

The present application is applied to a cluster storage system. The cluster storage system includes a plurality of nodes. The plurality of nodes are divided into a plurality of groups. Each group includes a proxy node that manages a lock resource and a non-proxy node that does not manage a lock resource. The proxy node in each group manages a part of all lock resources. For example, as shown in FIG. 1, nodes in a cluster storage system are divided into three groups, a group 1, a group 2, and a group 3. Each group includes a proxy node represented by a solid circle and at least one non-proxy node represented by a hollow circle. As shown in FIG. 1, there are a total of four lock resources in the cluster storage system, a lock resource 1, a lock resource 2, a lock resource 3, and a lock resource 4. The lock resource 1 may be managed by a proxy node in the group 3, the lock resource 2 may be managed by a proxy node in the group 2, and the lock resource 3 and the lock resource 4 may be managed by a proxy node in the group 1.

It should be noted that the node in the cluster storage system may be a storage server that provides a storage service. All lock resources may be distributed to all proxy nodes using a DHT algorithm, a consistent hash algorithm, or the like. Each proxy node manages a part of all the lock resources.

FIG. 2 is a flowchart of Embodiment 1 of a distributed lock management method according to the present application. The method is applied to a cluster storage system. The cluster storage system includes a plurality of nodes. The plurality of nodes are divided into a plurality of groups. Each group includes a proxy node that manages a lock resource and a non-proxy node that does not manage a lock resource. The proxy node in each group manages a part of all lock resources. As shown in FIG. 2, the method in this embodiment may include the following steps.

Step 201: A second node generates a first lock request message.

In this step, the first lock request message is used to apply to the first node for first lock permission corresponding to a first lock resource. Optionally, the first lock request message may include an identifier of the first lock resource.

Step 202: The second node sends the first lock request message to the first node.

In this step, the first node and the second node are nodes in a first group, the first node is a proxy node in the first group, and the second node is a non-proxy node in the first group. It should be noted that the first group is any group in the plurality of groups. The first lock resource may be a lock resource managed by the first node, or the first lock resource may be a lock resource managed by a proxy node in another group.

Step 203: The first node sends a first lock grant message to the second node according to the first lock request message.

In this step, the first lock grant message is used to grant the first lock permission to the second node.

In this embodiment, all nodes in the cluster storage system are divided into a plurality of groups, each group includes the proxy node that manages the lock resource and the non-proxy node that does not manage the lock resource, and the proxy node in each group manages a part of all lock resources. When a non-proxy node in a group needs to apply for lock permission, the non-proxy node applies to a proxy node in the group, and the proxy node in this group grants the lock permission to the non-proxy node in the group. In this way, the non-proxy node needs to know only the proxy node in the group that includes the non-proxy node, and directly applies to the proxy node when applying for the lock permission. The non-proxy node does not need to know a lock directory. Therefore, when the non-proxy node in the group changes (for example, being faulty or in recovery), a layout of the lock resource on the node does not change, and the lock directory does not need to be updated. The lock directory needs to be updated only when the proxy node changes. In the other approaches, when any node in the cluster storage system changes, lock directories of all nodes need to be updated. In comparison with the other approaches, a lock directory update time is reduced. A node can provide a lock service only when the lock directories are updated to be consistent. Therefore, in the present application, a lock service interruption time is reduced, and lock service availability is improved.

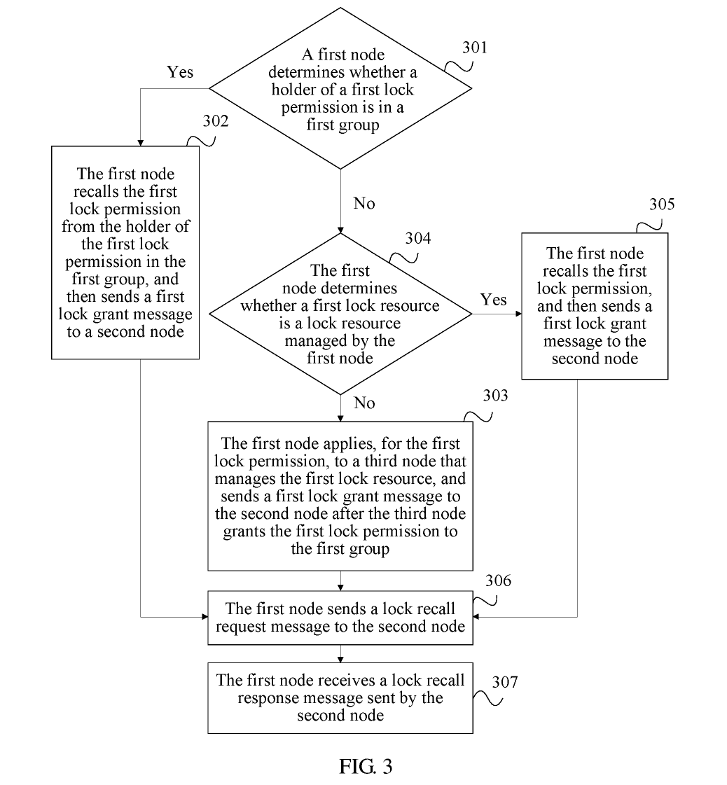

FIG. 3 is a flowchart of embodiment 2 of a distributed lock management method according to the present application. As shown in FIG. 3, the method in this embodiment is based on the method embodiment shown in FIG. 2. The method includes the following steps.

Step 301: The first node determines whether a holder of the first lock permission is in the first group.

In this step, when the holder of the first lock permission is in the first group, step 302 is performed. When the holder of the first lock permission is not in the first group, step 303 is performed. When the holder of the first lock permission is any node in the first group, it is considered that the holder of the first lock permission is in the first group. It should be noted that the holder of the first lock permission may be considered as a node that holds the first lock permission. When the first node manages the first lock resource, and the first node does not grant the first lock permission to any node in the cluster storage system, or the first node grants the first lock resource to the first node, it may be considered that the holder of the first lock permission is the first node. When the first lock permission is granted to another node in the first group, it may be considered that the other node is the holder of the first lock permission.

Step 302: The first node recalls the first lock permission from the holder of the first lock permission in the first group, and then sends the first lock grant message to the second node.

In this step, optionally, when the node that holds the first lock permission is not the first node, the first node may send, to the node that holds the first lock permission, a message that is used to recall the first lock permission, and send the first lock grant message to the second node after receiving a message that is returned by the node holding the first lock permission and that is used to indicate that the first lock permission is released. When the node holding the first lock permission is the first node, the first node sends the first lock grant message to the second node after determining that the first node releases the first lock permission.

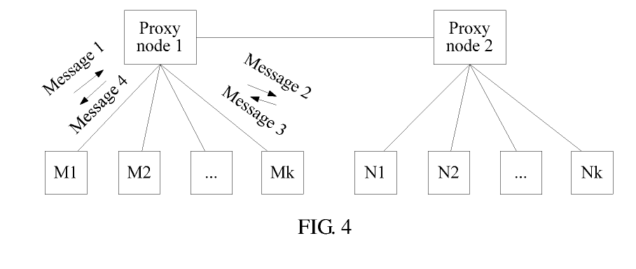

For example, as shown in FIG. 4, proxy node 1 and non-proxy nodes M1 to Mk are in a same group, proxy node 2 and non-proxy nodes N1 to Nk are in a same group, the proxy node 2 manages a lock resource 1, and lock permission of the lock resource 1 is lock permission 1. The non-proxy node M1 (that is, the second node) sends, to the proxy node 1 (that is, the first node), a message 1 that is used to apply to the proxy node 1 for the lock permission 1. The proxy node 1 determines that the lock permission 1 is granted to the non-proxy node Mk (that is, a holder of the lock permission 1 is in a first group), and sends, to the non-proxy node Mk, a message 2 that is used to recall the lock permission 1 from the non-proxy node Mk. After receiving a message 3 that is sent by the non-proxy node Mk and that is used to indicate that the lock permission 1 is released, the proxy node 1 sends, to the non-proxy node M1, a message 4 that is used to grant the lock permission 1 to the non-proxy node M1. It can be learned that, in a whole process of granting the lock permission, a message does not need to be sent to the proxy node 2 that manages the lock resource 1. Optionally, when nodes in a same group are in a same region, in the other approaches, lock permission needs to be applied to a node that manages the lock permission, and in comparison with the other approaches, a quantity of times of cross-region interaction is reduced. It can be learned from FIG. 4 that when the holder of the lock permission and an applier of the lock permission (that is, the node that applies for the lock permission) are in a same group, in this embodiment, a quantity of times of network communications between groups may be effectively reduced. Particularly, when the node that manages the lock resource, the applier of the lock permission, and the holder of the lock permission are in different regions, a quantity of times of cross-region communications is effectively reduced, and a delay of lock applying is reduced. It should be noted that a region may be divided in different manners. For example, it may be considered that a same equipment room is a same region, and different equipment rooms are different regions. For another example, it may be considered that a same city is a same region, and different cities are different regions. For example, in an active-active disaster recovery scenario, areas in which a same system is deployed may be considered as a same region, and areas in which different systems are deployed may be considered as different regions.

Step 303: The first node applies, for the first lock permission, to a third node that manages the first lock resource, and sends the first lock grant message to the second node after the third node grants the first lock permission to the first group.

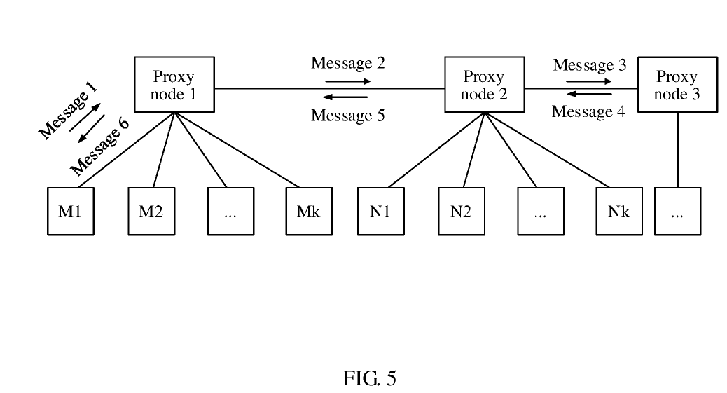

In this step, the third node is a proxy node in a second group. For example, as shown in FIG. 5, a proxy node 1 and non-proxy nodes M1 to Mk are in a group 1, a proxy node 2 and non-proxy nodes N1 to Nk are in a group 2, a proxy node 3 is in a group 3, the proxy node 2 manages a lock resource 1, and the lock resource 1 corresponds to lock permission 1. The non-proxy node M1 (that is, the second node) sends, to the proxy node 1 (that is, the first node), a message 1 that is used to apply to the proxy node 1 for the lock permission 1. The proxy node 1 determines that a holder of the lock permission 1 is not in the group including the proxy node 1 (that is, the holder of the lock permission 1 is not in the group 1), and therefore, sends, to the proxy node 2 that manages the lock resource 1, a message 2 that is used to apply to the proxy node 2 for the lock permission 1. After determining that the lock permission 1 is granted to the group 3, the proxy node 2 sends, to the proxy node 3 in the group 3, a message 3 that is used to recall the lock permission 1. After receiving a message 4 that is returned by the proxy node 3 and that is used to release the lock permission 1, the proxy node 2 sends, to the proxy node 1, a message 5 that is used to grant the lock permission 1 to the proxy node 1. After receiving the message 5, the proxy node 1 sends, to the non-proxy node 1, a message 6 that is used to grant the lock permission 1 to the non-proxy node Ml. It can be learned that, only when the holder of the lock permission is not in the group, the message is sent to the proxy node that manages the lock resource.

It should be noted that, when the first lock resource is not managed by the first node, the first node may also notify the second node which node manages the first lock resource, and the second node applies for the lock permission to the node that manages the first lock resource. The node that manages the first lock resource grants the lock permission to the second node such that the non-proxy node in the group obtains the lock permission.

Optionally, before step 303, the method may further include step 304.

Step 304: The first node determines whether the first lock resource is a lock resource managed by the first node.

In this step, when the first lock resource is the lock resource managed by the first node, step 305 is performed. When the first lock resource is not the lock resource managed by the first node, step 303 is performed.

Step 305: The first node recalls the first lock permission, and then sends the first lock grant message to the second node.

In this step, when the first lock permission is granted to a node in the first group, the recalling the first lock permission may include recalling the first lock permission from the node in the first group. When the first lock permission is granted to another group, the recalling the first lock permission may include recalling the first lock permission from a proxy node in the other group.

Optionally, before step 305, the method may further include determining, by the first node, whether the first lock permission is granted, and if the first lock permission is granted, step 305 is performed, or if the first lock permission is not granted, the first node may directly send the first lock grant message to the second node, that is, the first node directly grants the first lock permission to the second node.

Optionally, after the first node sends the first lock grant message to the second node, the method may further include step 306 and step 307 in the following.

Step 306: The first node sends a lock recall request message to the second node.

In this step, the lock recall request message is used to recall the first lock permission from the second node. It should be noted that a condition that triggers the first node to send the lock recall request message to the second node may be that another non-proxy node other than the second node in the first group or the first node applies for the first lock permission, or that the third node recalls the first lock permission from the first node.

Step 307: The first node receives a lock recall response message sent by the second node.

In this step, the lock recall response message is used to release the first lock permission. It should be noted that, “recalling” is an operation opposite to “granting”. After lock permission is granted to a node, the lock permission may be recalled from the node, and then the lock permission is granted to another node after the recalling.

It should be noted that, a plurality of nodes in a same group may determine, in a specific manner, a proxy node in the plurality of nodes in the group. Optionally, the proxy node may be determined according to consistent hash values of the plurality of nodes. Further, a node with a smallest hash value that is in a hash ring formed by the consistent hash values of the plurality of nodes is determined as the proxy node, or a node corresponding to a largest hash value that is in a hash ring formed by the consistent hash values of the plurality of nodes is determined as the proxy node. Therefore, before step 201, the method may further include determining, by the first node, the first node as a proxy node in the first group. Further, the first node determines the first node as the proxy node according to consistent hash values of all nodes in the first group. For example, the first node determines that the first node corresponding to a smallest hash value (or a largest hash value) that is in a hash ring formed by the consistent hash values of all nodes in the first group is the proxy node.

In this embodiment, when the holder of the first lock permission is in the first group, the first node recalls the first lock permission from the holder of the first lock permission in the first group, and then sends the first lock grant message to the second node. When the holder of the first lock permission is not in the first group, the first node applies, for the first lock permission, to the third node that manages the first lock resource, and sends the first lock grant message to the second node after the third node grants the first lock permission to the first group. In this way, although the first lock resource is not managed by the first node, when the holder of the first lock permission is in the first group, the first node can change a node that is in the first group and that holds the first lock permission. In the other approaches, any node needs to apply, for the first lock permission, to the node that manages the first lock resource. In comparison with the other approaches, a quantity of times of interaction with the node that manages the first lock resource is reduced.

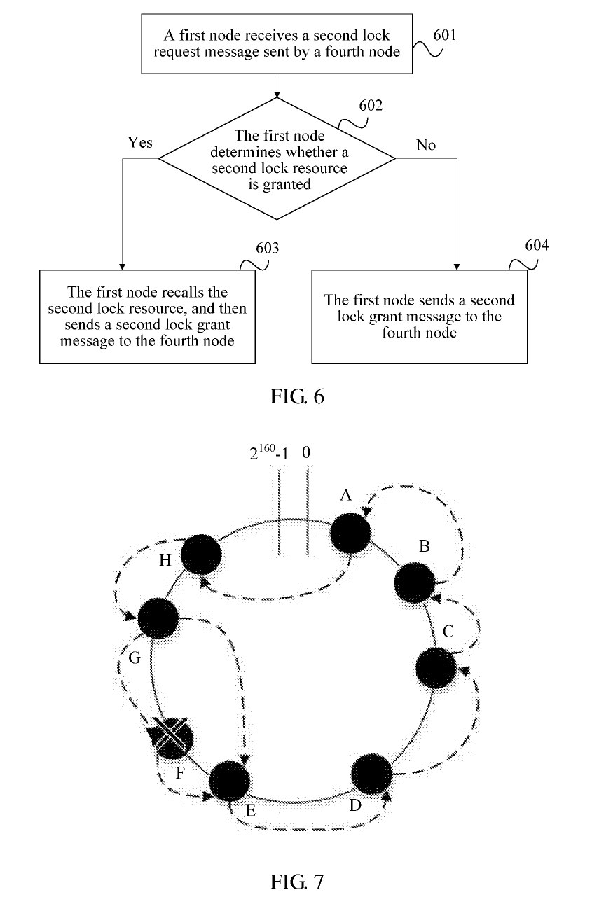

FIG. 6 is a flowchart of embodiment 3 of a distributed lock management method according to the present application. The distributed lock management method in this embodiment is based on the embodiment shown in FIG. 2 or FIG. 3, and mainly describes a process in which a proxy node in another group (that is, a fourth node) applies to the node in the first group (that is, the first node) for the lock permission. As shown in FIG. 6, the method in this embodiment may include the following steps.

Step 601: The first node receives a second lock request message sent by the fourth node.

In this step, the second lock request message is used by a third group to apply to the first node for second lock permission corresponding to a second lock resource. The second lock resource is managed by the first node, and the fourth node is a proxy node in the third group.

Step 602: The first node determines whether the second lock resource is granted.

In this step, step 603 is performed when the first node determines that the second lock permission is granted (that is, the second lock permission is granted to a node in the group, or is granted to another group). Step 604 is performed when the first node determines that the second lock permission is not granted.

Step 603: The first node recalls the second lock resource, and then sends a second lock grant message to the fourth node.

In this step, the second lock grant message is used to grant the second lock permission to the third group. Optionally, when the second lock resource is granted to a non-proxy node in the first group, that the first proxy node recalls the second lock resource includes recalling, by the first node, the second lock resource from the non-proxy node in the first group. When the second lock resource is granted to a fourth group, that the first node recalls the second lock resource includes recalling, by the first node, the second lock resource from a proxy node in the fourth group.

It should be noted that a procedure ends after step 603 is performed.

Step 604: The first node sends a second lock grant message to the fourth node.

In this step, the second lock grant message is used to grant the second lock permission to the third group.

In this embodiment, the first node receives the second lock request message sent by the fourth node (that is, the other proxy node), and the second lock request message is used by the group including the fourth node to apply to the first node for the second lock permission corresponding to the second lock resource managed by the first node. When the second lock permission is granted, the first node recalls the second lock permission, and then grants the second lock permission to the group including the fourth node. When the second lock permission is not granted, the first node directly grants the second lock permission to the group including the fourth node. In this way, the proxy node grants and recalls the lock permission corresponding to the lock resource managed by the proxy node.

Optionally, based on any one of embodiment 1 to embodiment 3 of the distributed lock management method in the present application, nodes in a group (for example, the first group) may monitor each other in order to determine whether a node in the group is faulty and which node is faulty. FIG. 7 is a schematic diagram of node monitoring in a group according to the present application. As shown in FIG. 7, the group includes eight nodes, a node A to a node H, consistent hash values of the nodes A to H successively increase, and the consistent hash values of the nodes A to H form a hash ring shown in FIG. 7. Each node monitors whether a node previous to the node is faulty. For example, a monitoring relationship between the nodes in FIG. 7 is that a node B monitors the node A (that is, the node A is a node previous to the node B), a node C monitors the node B (that is, the node B is a node previous to the node C), and so on (it should be noted that the monitoring relationship between the nodes may alternatively be that the node B monitors the node C, the node C monitors the node D, and so on). When a node (may be a proxy node in the group or a non-proxy node in the group) learns, by means of monitoring, that a node previous to the node is faulty, the node updates the hash ring, and instructs another node other than the faulty node in the group to update the hash ring. For example, in FIG. 7, a node G may learn, by means of monitoring, that a node F is faulty. Because the hash ring is updated, a node previous to the node G is updated with a node E, that is, the node G monitors the node E.

In FIG. 7, when a node corresponding to a smallest hash value in the hash ring is selected as the proxy node, the node A is the proxy node. When the node F is faulty, a layout of a lock resource does not change. Therefore, a lock directory does not need to be updated, and a lock service is not interrupted. For the node A, if the node A grants the lock permission to the node F before the node F becomes faulty, after the node F is faulty, it may be considered that the node F releases the lock permission.

It should be noted that, when the proxy node in the group is faulty, for example, the node A is faulty, the node G that monitors the node A updates the hash ring, and instructs another node other than the node A in the group to update the hash ring. When the hash ring is updated, a node B with a smallest hash value becomes a new proxy node. The new proxy node asks another node in the group for a hold status of lock permission (that is, a node holds which lock permission). In addition, because the proxy node changes, the layout of the lock resource on the proxy node in the cluster storage system may change. When the layout changes, each proxy node needs to update the lock directory.

It should be noted that, when a new node is added to the group, if the new node cannot become a new proxy node in the group, the layout of the lock resource does not change, and therefore, the lock directory does not need to be updated, and the lock service is not interrupted. If the new node becomes a new proxy node in the group, the new proxy node may directly learn the hold status of the lock permission in the group from an original proxy node. In addition, because the proxy node changes, the layout of the lock resource on the proxy node in the cluster storage system may change. When the layout changes, each proxy node needs to update the lock directory.

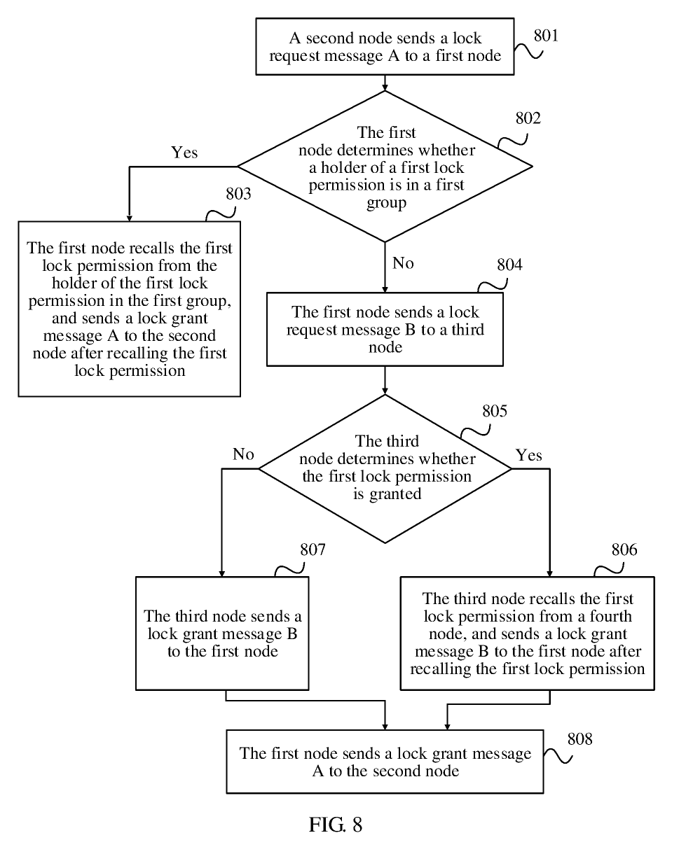

FIG. 8 is a flowchart of embodiment 5 of a distributed lock management method according to the present application. In this embodiment, an example in which a third node manages first lock permission corresponding to a first lock resource is used for description. As shown in FIG. 8, the method in this embodiment may include the following steps.

Step 801: A second node sends a lock request message A to a first node.

In this step, the lock request message A is used to request, from the first node, the first lock permission corresponding to a first lock resource. The second node and the first node are nodes in a first group. The first node is a proxy node in the first group, and the second node is a non-proxy node in the first group.

Step 802: The first node determines whether a holder of the first lock permission is in a first group.

When the holder of the first lock permission is in the first group, the first node performs step 803, or when the holder of the first lock permission is not in the first group, the first node performs step 804.

Step 803: The first node recalls the first lock permission from the holder of the first lock permission in the first group, and sends a lock grant message A to the second node after recalling the first lock permission.

In this step, the lock grant message A is used to grant the first lock permission to the second node.

It should be noted that a procedure ends after step 803 is performed.

Step 804: The first node sends a lock request message B to the third node.

In this step, the lock request message B is used to request the first lock permission from the third node. The third node is a node that manages the first lock resource. It should be noted that the third node which is a proxy node that manages the first lock resource, and the third node is in another group other than the first group.

Step 805: The third node determines whether the first lock permission is granted.

In this step, when the first lock permission is granted, the third node performs step 806, or when the first lock permission is not granted, the third node performs step 807.

Step 806: The third node recalls the first lock permission from a fourth node, and sends a lock grant message B to the first node after recalling the first lock permission.

In this step, the fourth node is a proxy node that holds the first lock permission, and the fourth node is in another group other than the group including the first node and the second node. The lock grant message B is used to grant the first lock permission to the first group.

It should be noted that step 808 is performed after step 806 is performed.

Step 807: The third node sends a lock grant message B to the first node.

In this step, the lock grant message B is used to grant the first lock permission to the first group.

Step 808: The first node sends a lock grant message A to the second node.

In this step, the lock grant message A is used to grant the first lock permission to the second node.

It should be noted that, when a plurality of nodes (the plurality of nodes may include a non-proxy node and another proxy node) request same lock permission from a proxy node, the proxy node may successively grant the lock permission to the plurality of nodes according to a sequence in which the plurality of nodes apply for the same lock permission. That is, the proxy node first grants the lock permission to a node that is the first in the plurality of nodes to apply for the lock permission. After the node that first applies for the lock permission releases the lock permission, the proxy node grants the lock permission to a node that is the second in the plurality of nodes to apply for the lock permission. After the node that second applies for the lock permission releases the lock permission, the proxy node grants the lock permission to a node that is the third in the plurality of nodes to apply for the lock permission, and so on.

In this embodiment, when the holder of the first lock permission is in the first group, the first node recalls the first lock permission from a node that holds the first lock permission in the first group, and then sends the lock grant message A to the second node. When determining that the holder of the first lock permission is not in the first group, the first node applies, for the first lock permission, to the third node that manages the first lock resource, and sends the lock grant message A to the second node after the third node grants the first lock permission to the first group. In this way, although the first lock resource is not managed by the first node, when the holder of the first lock permission is in the first group, the first node can change a node that is in the first group and that holds the first lock permission. In the other approaches, any node needs to apply, for the first lock permission, to the node that manages the first lock resource. In comparison with the other approaches, a quantity of times of interaction with the node that manages the first lock resource is reduced.

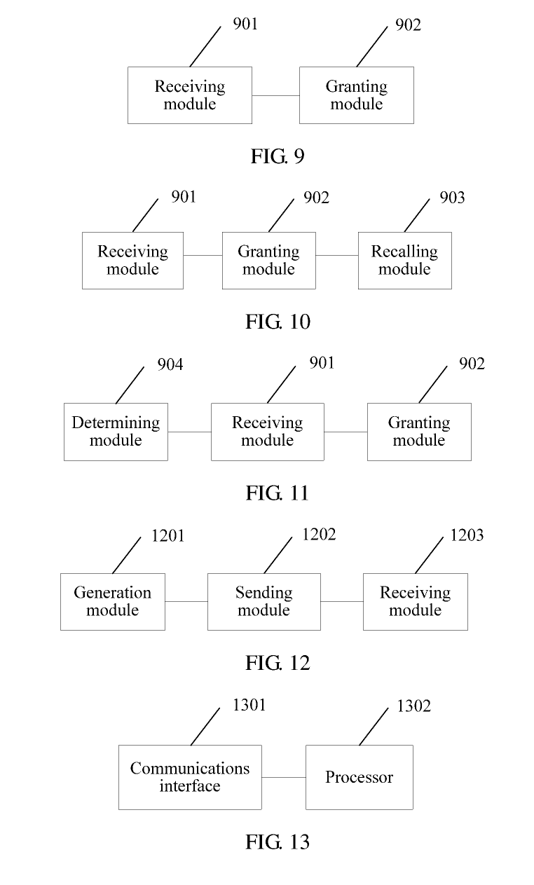

FIG. 9 is a schematic structural diagram of Embodiment 1 of a distributed lock management apparatus according to the present application. The apparatus is applied to a cluster storage system. The cluster storage system includes a plurality of nodes. The plurality of nodes are divided into a plurality of groups. Each group includes a proxy node that manages a lock resource and a non-proxy node that does not manage a lock resource. The proxy node in each group manages a part of all lock resources. The apparatus may be a first node. As shown in FIG. 9, the apparatus includes a receiving module 901 and a granting module 902. The receiving module 901 is configured to receive a first lock request message sent by a second node. The first lock request message is used to apply to the first node for first lock permission corresponding to a first lock resource. The first node is a proxy node in the first group, and the second node is a non-proxy node in the first group. The granting module 902 is configured to send a first lock grant message to the second node according to the first lock request message. The first lock grant message is used to grant the first lock permission to the second node.

The apparatus in this embodiment may be configured to perform the technical solution on a first node side in the method embodiment shown in FIG. 2. An implementation principle and a technical effect of the apparatus are similar to those in the method embodiment, and details are not described herein again.

FIG. 10 is a schematic structural diagram of embodiment 2 of a distributed lock management apparatus according to the present application. As shown in FIG. 10, based on the structure of the apparatus shown in FIG. 9, the apparatus in this embodiment may further include a recalling module 903. The recalling module 903 is configured to send a lock recall request message to the second node, where the lock recall request message is used to recall the first lock permission from the second node, and receive a lock recall response message sent by the second node, where the lock recall response message is used to release the first lock permission.

Optionally, the granting module 902 is further configured to determine whether a holder of the first lock permission is in the first group, and if the holder of the first lock permission is in the first group, recall the first lock permission from the holder of the first lock permission in the first group, and then send the first lock grant message to the second node.

Alternatively, the granting module 902 is further configured to determine whether a holder of the first lock permission is in the first group, and if the holder of the first lock permission is not in the first group, apply, for the first lock permission, to a third node that manages the first lock resource, and send the first lock grant message to the second node after the third node grants the first lock permission to the first group.

The third node is a proxy node in a second group.

Optionally, nodes in a same group are in a same region.

The apparatus in this embodiment may be configured to perform the technical solutions on a first node side in the method embodiment shown in FIG. 3 and the method embodiment shown in FIG. 8. An implementation principle and a technical effect of the apparatus are similar to those in the method embodiment, and details are not described herein again.

Optionally, based on embodiment 1 or embodiment 2 of the distributed lock management apparatus of the present application, the receiving module 901 is further configured to receive a second lock request message sent by a fourth node, where the second lock request message is used by a third group to apply to the first node for second lock permission corresponding to a second lock resource, where the second lock resource is managed by the first node, and the fourth node is a proxy node in the third group, and the granting module 902 is further configured to determine whether the second lock resource is granted, and if the second lock resource is granted, recall the second lock resource, and then send a second lock grant message to the fourth node, where the second lock grant message is used to grant the second lock permission to the third group.

Optionally, when the second lock resource is granted to a non-proxy node in the first group, that the granting module 902 recalls the second lock resource further includes recalling the second lock resource from the non-proxy node in the first group.

Optionally, when the second lock resource is granted to a fourth group, that the granting module 902 recalls the second lock resource further includes recalling the second lock resource from a proxy node in the fourth group.

The apparatus in this embodiment may be configured to perform the technical solution of the method embodiment shown in FIG. 6. An implementation principle and a technical effect of the apparatus are similar to those in the method embodiment, and details are not described herein again.

FIG. 11 is a schematic structural diagram of embodiment 4 of a distributed lock management apparatus according to the present application. As shown in FIG. 11, based on the structure of the apparatus shown in FIG. 9, the apparatus in this embodiment may further include a determining module 904. The determining module 904 is configured to determine the first node as a proxy node in the first group.

Optionally, the determining module 904 is further configured to determine the first node as the proxy node according to consistent hash values of all nodes in the first group.

Optionally, the apparatus in this embodiment may further include a monitoring module configured to monitor whether a node previous to the first node in a hash ring formed by the consistent hash values of all nodes is faulty, and if the node previous to the first node is faulty, update, by the first node, the hash ring, and instruct another node other than the previous node in the first group to update the hash ring.

The apparatus in this embodiment may be configured to perform the technical solution on a first node side in embodiment 4 of the distributed lock management method. An implementation principle and a technical effect of the apparatus are similar to those in the method embodiment, and details are not described herein again.

FIG. 12 is a schematic structural diagram of embodiment 5 of a distributed lock management apparatus according to the present application. The apparatus is applied to a cluster storage system. The cluster storage system includes a plurality of nodes. The plurality of nodes are divided into a plurality of groups. Each group includes a proxy node that manages a lock resource and a non-proxy node that does not manage a lock resource. The proxy node in each group manages a part of all lock resources. The apparatus may be a second node. As shown in FIG. 12, the apparatus includes a generation module 1201, a sending module 1202, and a receiving module 1203. The generation module 1201 is configured to generate a first lock request message. The first lock request message is used to apply to a first node for first lock permission corresponding to a first lock resource. The first node is a proxy node in the first group, and the second node is a non-proxy node in the first group. The sending module 1202 is configured to send the first lock request message to the first node. The receiving module 1203 is configured to receive a first lock grant message sent by the first node. The first lock grant message is used to grant the first lock permission to the second node.

The apparatus in this embodiment may be configured to perform the technical solution on a second node side in the method embodiment shown in FIG. 2. An implementation principle and a technical effect of the apparatus are similar to those in the method embodiment, and details are not described herein again.

Optionally, based on embodiment 5 of the distributed lock management apparatus in the present application, the receiving module 1203 is further configured to receive a lock recall request message sent by the first node. The lock recall request message is used to recall the first lock permission from the second node. The sending module 1202 is further configured to send a lock recall response message to the first node after the first lock permission is released. The lock recall response message is used to release the first lock permission.

Optionally, nodes in a same group are in a same region.

Optionally, the apparatus in this embodiment may further include a monitoring module configured to monitor whether a node previous to the second node in the hash ring formed by the consistent hash values of all nodes in the first group is faulty, and if the node previous to the second node is faulty, update, by the second node, the hash ring, and instruct another node other than the previous node in the first group to update the hash ring.

The apparatus in this embodiment may be configured to perform the technical solutions on a second node side in the method embodiment shown in FIG. 3 and Embodiment 4 of the distributed lock management method. An implementation principle and a technical effect of the apparatus are similar to those in the method embodiment, and details are not described herein again.

The present application further provides a distributed lock management system, including the apparatus described in any one of embodiment 1 to embodiment 4 of the distributed lock management apparatus, and the apparatus described in any one of Embodiment 5 to Embodiment 7 of the distributed lock management apparatus.

FIG. 13 is a schematic structural diagram of embodiment 7 of a distributed lock management apparatus according to the present application. The apparatus is applied to a cluster storage system. The cluster storage system includes a plurality of nodes. The plurality of nodes are divided into a plurality of groups. Each group includes a proxy node that manages a lock resource and a non-proxy node that does not manage a lock resource. The proxy node in each group manages a part of all lock resources. The apparatus may be a first node. As shown in FIG. 13, the apparatus includes a communications interface 1301 and a processor 1302. The communications interface 1301 is configured to receive a first lock request message sent by a second node. The first lock request message is used to apply to the first node for first lock permission corresponding to a first lock resource. The first node is a proxy node in the first group, and the second node is a non-proxy node in the first group. The processor 1302 is configured to determine, according to the first lock request message, to grant the first lock permission to the second node. The communications interface 1301 is further configured to send a first lock grant message to the second node. The first lock grant message is used to grant the first lock permission to the second node.

Optionally, the communications interface 1301 is further configured to send a lock recall request message to the second node, where the lock recall request message is used to recall the first lock permission from the second node, and receive a lock recall response message sent by the second node, where the lock recall response message is used to release the first lock permission.

Optionally, the processor 1302 is further configured to determine whether a holder of the first lock permission is in the first group, and if the holder of the first lock permission is in the first group, recall the first lock permission from a node that holds the first lock permission in the first group. That the communications interface 1301 sends the first lock grant message to the second node further includes sending the first lock grant message to the second node after the processor 1302 recalls the first lock permission from the holder of the first lock permission in the first group.

Alternatively, the processor 1302 is further configured to determine whether a holder of the first lock permission is in the first group, and if the holder of the first lock permission is not in the first group, apply for the first lock permission from a third node that manages the first lock resource. That the communications interface 1301 sends a first lock grant message to the second node further includes sending the first lock grant message to the second node after the third node grants the first lock permission to the first group, where the third node is a proxy node in a second group.

Optionally, nodes in a same group are in a same region.

Optionally, the communications interface 1301 is further configured to receive a second lock request message sent by a fourth node. The second lock request message is used by a third group to apply to the first node for second lock permission corresponding to a second lock resource. The second lock resource is managed by the first node. The fourth node is a proxy node in the third group.

Correspondingly, the processor 1302 is further configured to determine whether the second lock resource is granted, and if the second lock resource is granted, recall the second lock resource. The communications interface 1301 is further configured to send a second lock grant message to the fourth node after the second lock resource is recalled. The second lock grant message is used to grant the second lock permission to the third group.

Optionally, when the second lock resource is granted to the non-proxy node in the first group, that the processor 1302 recalls the second lock resource further includes recalling the second lock resource from the non-proxy node in the first group.

Optionally, when the second lock resource is granted to the fourth group, that the processor 1302 recalls the second lock resource further includes recalling the second lock resource from a proxy node in the fourth group.

Optionally, the processor 1302 is further configured to determine the first node as a proxy node in the first group.

Optionally, that the processor 1302 determines the first node as the proxy node in the first group further includes determining the first node as the proxy node according to consistent hash values of all nodes in the first group.

Optionally, the processor 1302 is further configured to monitor whether a node previous to the first node in a hash ring formed by the consistent hash values of all nodes is faulty, and if the node previous to the first node is faulty, update, by the first node, the hash ring, and instruct another node other than the previous node in the first group to update the hash ring.

The apparatus in this embodiment may be configured to perform the technical solutions on a first node side in the method embodiments shown in FIG. 2, FIG. 3, FIG. 6, and FIG. 8, and Embodiment 4 of the distributed lock management method. An implementation principle and a technical effect of the apparatus are similar to those in the method embodiment, and details are not described herein again.

The apparatus in this embodiment is applied to a cluster storage system. The cluster storage system includes a plurality of nodes. The plurality of nodes are divided into a plurality of groups. Each group includes a proxy node that manages a lock resource and a non-proxy node that does not manage a lock resource. The proxy node in each group manages a part of all lock resources. The apparatus may be a second node. A structure of the apparatus in this embodiment is similar to a structure of the apparatus shown in FIG. 13, and the apparatus may also include a communications interface and a processor. The processor is configured to generate a first lock request message. The first lock request message is used to apply to a first node for first lock permission corresponding to a first lock resource. The first node is a proxy node in the first group, and the second node is a non-proxy node in the first group. The communications interface is configured to send the first lock request message to the first node. The communications interface is further configured to receive a first lock grant message sent by the first node. The first lock grant message is used to grant the first lock permission to the second node.

Optionally, the communications interface is further configured to receive a lock recall request message sent by the first node, where the lock recall request message is used to recall the first lock permission from the second node, and send a lock recall response message to the first node after the first lock permission is released, where the lock recall response message is used to release the first lock permission.

Optionally, nodes in a same group are in a same region.

Optionally, the processor is further configured to monitor whether a node previous to the second node in the hash ring formed by the consistent hash values of all nodes in the first group is faulty, and if the node previous to the second node is faulty, update, by the second node, the hash ring, and instruct another node other than the previous node in the first group to update the hash ring.

The apparatus in this embodiment may be configured to perform the technical solutions on a second node side in the method embodiments shown in FIG. 2 and FIG. 3, and Embodiment 4 of the distributed lock management method. An implementation principle and a technical effect of the apparatus are similar to those in the method embodiment, and details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes any medium that can store program code, such as a read-only memory (ROM), a random access memory (RAM), a magnetic disk, or an optical disc.

Finally, it should be noted that the foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present application.

What is claimed is:

1. A distributed lock management method performed by a first node, comprising:
receiving a first lock request message from a second node, the first lock request message being used to apply to the first node for first lock permission corresponding to a first lock resource, the first node being a proxy node in a first group, and the second node being a non-proxy node in the first group; and
sending a first lock grant message to the second node according to the first lock request message, the first lock grant message being used to grant the first lock permission to the second node.

2. The method of claim 1, wherein sending the first lock grant message to the second node comprises:
determining whether a holder of the first lock permission is in the first group;
recalling the first lock permission from the holder of the first lock permission when the holder of the first lock permission is in the first group; and
sending the first lock grant message to the second node.

3. The method of claim 1, wherein sending the first lock grant message to the second node comprises:
determining whether a holder of the first lock permission is in the first group;
applying for the first lock permission to a third node that manages the first lock resource when the holder of the first lock permission is not in the first group; and
sending the first lock grant message to the second node after the third node grants the first lock permission to the first group, the third node being a proxy node in a second group.

4. The method of claim 1, further comprising:
receiving a second lock request message from a fourth node, the second lock request message being used by a third group to apply to the first node for second lock permission corresponding to a second lock resource, the second lock resource being managed by the first node, and the fourth node being a proxy node in the third group;
determining whether the second lock resource is granted;
recalling the second lock resource when the second lock resource is granted; and
sending a second lock grant message to the fourth node, the second lock grant message being used to grant the second lock permission to the third group.

5. The method of claim 4, wherein the second lock resource is granted to a non-proxy node in the first group, and recalling the second lock resources comprises recalling the second lock resource from the non-proxy node in the first group.

6. The method of claim 4, wherein the second lock resource is granted to a fourth group, and recalling the second lock resource comprises recalling the second lock resource from a proxy node in the fourth group.

7. The method of claim 1, wherein nodes in a same group are in a same region.

8. A first node, comprising:
a memory having a plurality of instructions stored thereon; and
a processor coupled the memory, the instructions causing the processor to be configured to:
receive a first lock request message from a second node, the first lock request message being used to apply to the first node for first lock permission corresponding to a first lock resource, the first node being a proxy node in a first group, and the second node being a non-proxy node in the first group; and
send a first lock grant message to the second node according to the first lock request message, the first lock grant message being used to grant the first lock permission to the second node.

9. The first node of claim 8, wherein in a manner of sending the first lock grant message to the second node, the instructions further cause the processor to be configured to:
determine whether a holder of the first lock permission is in the first group;
recall the first lock permission from the holder of the first lock permission when the holder of the first lock permission is in the first group; and
send the first lock grant message to the second node.

10. The first node of claim 8, wherein in a manner of sending the first lock grant message to the second node, the instructions further cause the processor to be configured to:
determine whether a holder of the first lock permission is in the first group;
apply for the first lock permission to a third node that manages the first lock resource when the holder of the first lock permission is not in the first group; and
send the first lock grant message to the second node after the third node grants the first lock permission to the first group, the third node being a proxy node in a second group.

11. The first node of claim 8, wherein the instructions further cause the processor to be configured to:
receive a second lock request message from a fourth node, the second lock request message being used by a third group to apply to the first node for second lock permission corresponding to a second lock resource, the second lock resource being managed by the first node, and the fourth node being a proxy node in the third group;
determine whether the second lock resource is granted;
recall the second lock resource when the second lock resource is granted; and
send a second lock grant message to the fourth node, the second lock grant message granting the second lock permission to the third group.

12. The first node of claim 11, wherein the second lock resource is granted to a non-proxy node in the first group, and the instructions further cause the processor to be configured to recall the second lock resource from the non-proxy node in the first group.

13. The first node of claim 11, wherein the second lock resource is granted to a fourth group and the fourth group is different from the first group, and the instructions further cause the processor to be configured to recall the second lock resource from a proxy node in the fourth group.

14. The first node of claim 8, wherein nodes in a same group are in a same region.

15. A computer-readable storage medium comprising instructions which, when executed by a computer, cause the computer to be configured to:
receive a first lock request message from a second node, the first lock request message being used to apply to the computer for first lock permission corresponding to a first lock resource, the computer being a proxy node in a first group and a first node, and the second node being a non-proxy node in the first group; and
send a first lock grant message to the second node according to the first lock request message, the first lock grant message being used to grant the first lock permission to the second node.

16. The computer-readable storage medium of claim 15, wherein in a manner of sending the first lock grant message to the second node, the instructions further cause the computer to be configured to:
determine whether a holder of the first lock permission is in the first group;
recall the first lock permission from the holder of the first lock permission when the holder of the first lock permission is in the first group; and
send the first lock grant message to the second node.

17. The computer-readable storage medium of claim 15, wherein in a manner of sending the first lock grant message to the second node, the instructions further cause the computer to be configured to:
determine whether a holder of the first lock permission is in the first group;
apply for the first lock permission to a third node managing the first lock resource when the holder of the first lock permission is not in the first group; and
send the first lock grant message to the second node after the third node grants the first lock permission to the first group, the third node being a proxy node in a second group.

18. The computer-readable storage medium of claim 15, wherein the instructions further cause the computer to be configured to:
receive a second lock request message from a fourth node, the second lock request message being used by a third group to apply to the computer for second lock permission corresponding to a second lock resource, the second lock resource being managed by the computer, and the fourth node being a proxy node in the third group;
determine whether the second lock resource is granted;
recall the second lock resource when the second lock resource is granted; and
send a second lock grant message to the fourth node, the second lock grant message granting the second lock permission to the third group.

19. The computer-readable storage medium of claim 18, wherein the second lock resource is granted to a non-proxy node in the first group, and the instructions further cause the computer to be configured to recall the second lock resource from the non-proxy node in the first group.

20. The computer-readable storage medium of claim 18, wherein the second lock resource is granted to a fourth group and the fourth group is different from the first group, and the instructions further cause the computer to be configured to recall the second lock resource from a proxy node in the fourth group.
